(19) United States
(12) Patent Application Publication
(10) Pub. No.: US 2005/0097459 A1
(43) Pub. Date: May 5, 2005

(54) System and method for user creation of personalized graphics

(76) Inventor: Michael Self, Fort Lauderdale, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/941,450

(22) Filed: Sep. 15, 2004

Related U.S. Application Data
(60) Provisional application No. 60/515,493, filed on Oct. 29, 2003.

(51) Int. Cl. G06F 15/00; G06F 19/00

(52) U.S. Cl. 715/517; 700/97

(57) ABSTRACT

The present invention describes a system and method for user creation of an individualized graphics media for display placement onto a material, by placement of the media onto a vehicle glass, including the user-directed computer-aided preparation of the customized media, as well as presenting the order processing and order fulfillment processes, the system is network based, whereby a user can access and manipulate software stored on a remote computer over said network, software contains tools and selections, allowing a user to customize an image and submit the individualized image to a manufacturer for printing onto a receptor media, after which it is shipped to the customer, including operation of the system in a client-server, Internet-based environment, where an Internet browser program acts as the user-interface between the user and the individualized image design and media procurement software tools.

### CROSS-REFERENCE TO RELATED APPLICATIONS

This application claims the benefit of U.S. Provisional Application Ser. No. 60/515,493, filed on Oct. 29, 2003, entitled METHOD FOR USER CREATION OF PERSONALIZED GRAPHICS.

### BACKGROUND OF THE INVENTION

The World-Wide computer communications network, known as the Internet, has emerged as a powerful marketing and sales tool. Product information retrieval and ordering through “the web” has become commonplace and even acknowledged leaders in the retail industry have whole departments entirely devoted to Internet marketing and order fulfillment. The global nature of the Internet has allowed niche businesses to gain substantial market share without incurring some of the costs of traditional “bricks and mortar” companies. As a result of the enhanced communications, information exchange between a business and its customers has become efficient and timely. Order customization is easier and quicker because of the “real-time” contact between customers and a manufacturer. The customized printing business in particular is one sector where a large communications network, like the Internet, can increase efficiency, enhance product choice, and reduce costs of production and distribution. The present invention, in the field of customized labels, relates to design, production and distribution of a computer-aided, graphical image applied on media that can be affixed to material. In particular, the preferred embodiment describes customized design, order processing and fulfillment over a computer network, such as the Internet, of media displayed on vehicular windows.

### SUMMARY OF THE INVENTION

The present invention describes a system and method for user creation of an individualized graphics media for display placement onto a non-opaque surface, such as a window. It consists of a user logging onto a computer network and using software tools to create an image transmitted to a manufacturer to be printed on graphics media, such as vinyl sheeting. Upon completing the steps involved with image creation, an order is either submitted to a intermediary ordering service, such as a retailer, who forwards the order to the manufacturer for order fulfillment, or the order is sent directly to the manufacturer from the user, where it is subsequently printed and the resulting media is shipped to the user.

The present invention uses computer software that is accessible from a computer network, such as the Internet. The computer software resides on one or more computer servers and can be accessed through an Internet browser or the like, which eliminates the need for a user to download any software to the client computer, e.g. a personal computer. The software contains tools and selections, such as text placement, graphic selection, color schemes, or the like, which allow the user to customize and submit the individualized image to the manufacturer from the software for printing onto a receptor media. The resulting media is packaged and shipped to the user, using the shipping information provided.

Advantages of the present invention to the user include increased flexibility for graphic image creation, shorter order processing and fulfillment times, and fully customizable product appearance. Advantages to the manufacturer include increased market share and efficient, direct customer service.

### BRIEF DESCRIPTION OF THE FIGURES

FIG. 1 gives a graphical overview of the system connectivity scheme for an embodiment of the present invention.

FIGS. 2 through 18 are screen capture images for an Internet based realization of the image creation software described herein.

### DETAILED DESCRIPTION OF THE PREFERRED EMBODIMENT

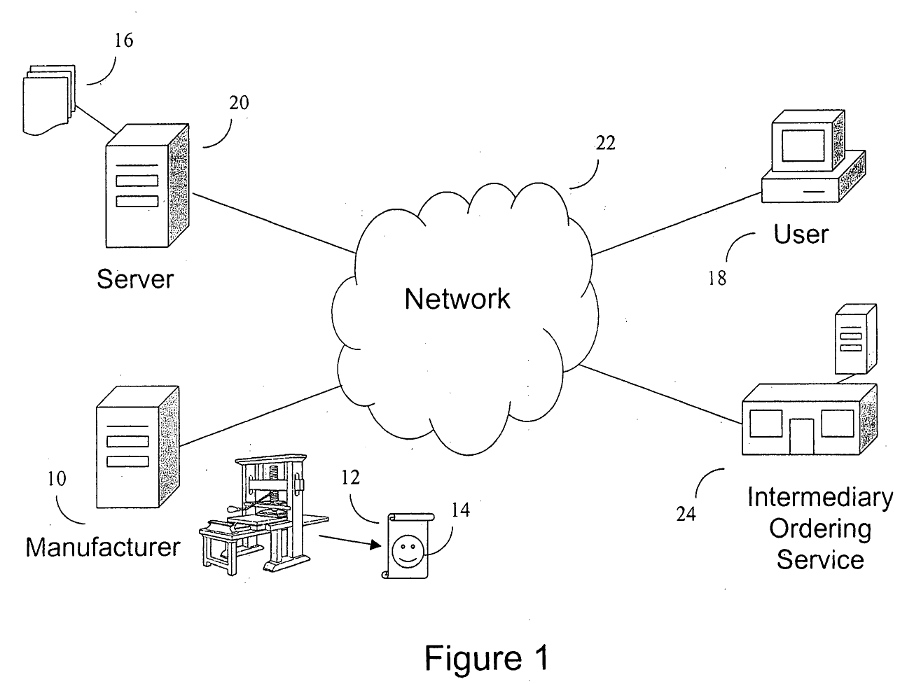

A preferred embodiment of the present invention is illustrated in FIG. 1, and includes a manufacturer 10 of a printed product 12, which may include posters, printed vinyl, or other printed graphic media, containing an individualized image 14. Manufacturer 10 or Intermediary Ordering Service 24 uses image creation software 16, which allows a user 18 to create individualized image 14 by making various graphical manipulations and selections.

Image creation software 16 is contained on a server 20, which is accessible to the user 18 by logging onto a computer network 22, such as the Internet, through such means as a network or Internet browser. Because image creation software 16 resides on server 20, there is no need for the user 18 to download and install any software to a client computer. Alternatively, a user may access the image creation software through an intermediary ordering service 24 either virtually through the network 22 or physically from a “bricks and mortar” retail location. The intermediary ordering service 24 forwards the order to the manufacturer 10 for product fulfillment.

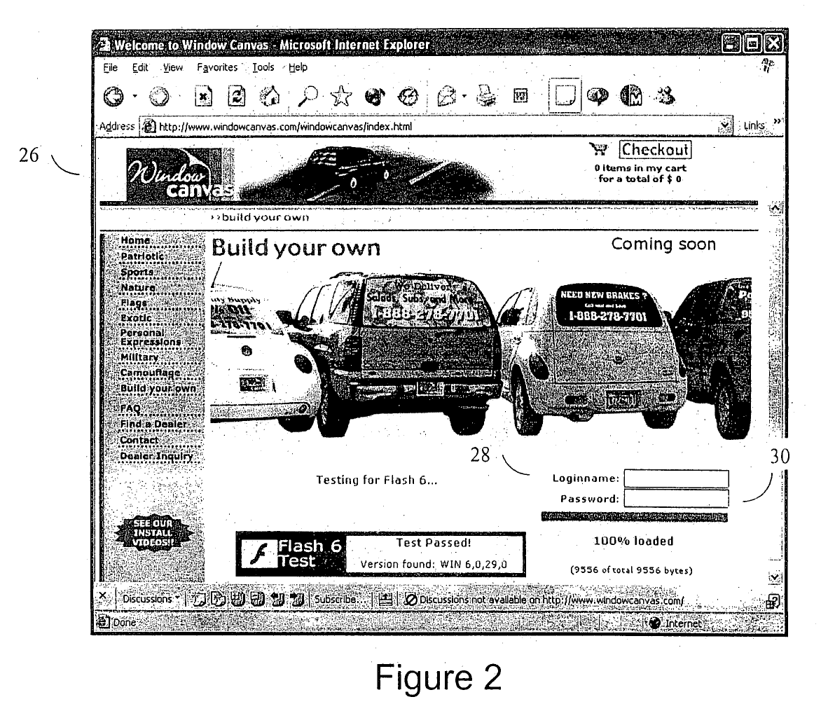

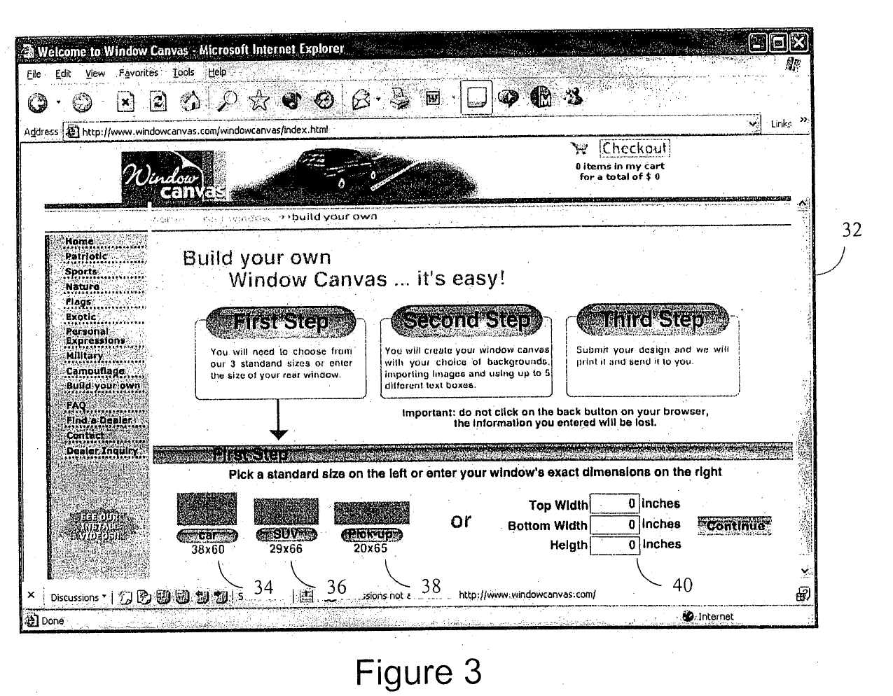

Upon logging onto computer network 22 to access image creation software 16, the user 18 is presented with a login screen 26, shown in FIG. 2. While viewing login screen 26, the user 18 is prompted to enter a login identification into a login identification field 28, as well as entering a password into a password field 30. After completing entry of login identification and password, the user 18 is directed to a size selection screen 32, shown in FIG. 3. The user 18 may select the desired size of printed product 12 that will contain the individualized image 14 from a choice of media sizing options including, for example, standard rear window sizes such as car 34, SUV 36, pick-up 38. A custom size entry 40, permits the user 18 to specify the linear measurements of the object on which the media is to be placed.

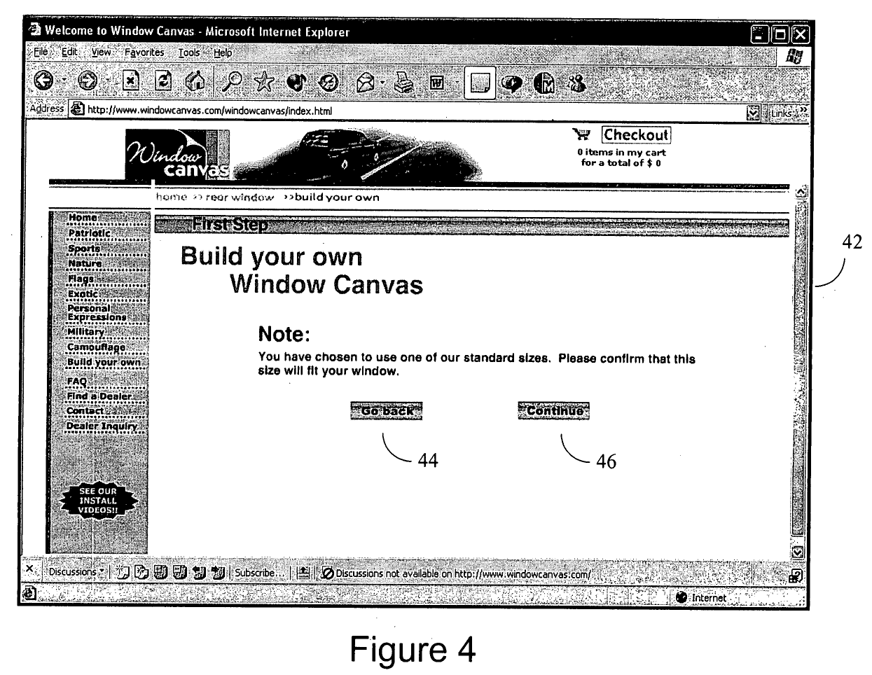

Following selection of the product size, the user 18 is prompted to confirm the size selection through a size selection confirmation screen 42, and can edit the entry by choosing the go back option 44 or proceed to the next process by selecting the continue option 46, as shown in FIG. 4.

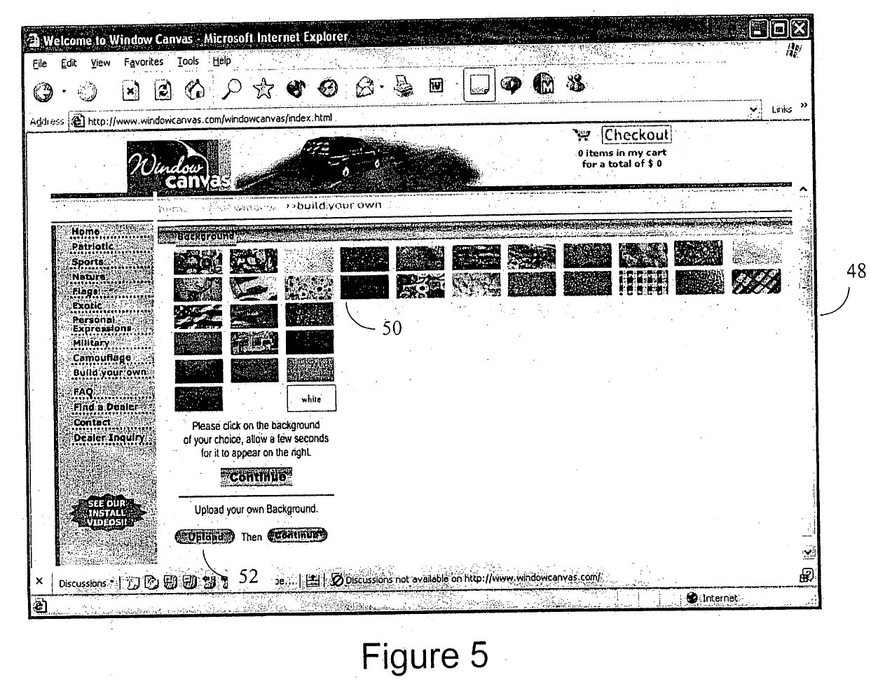

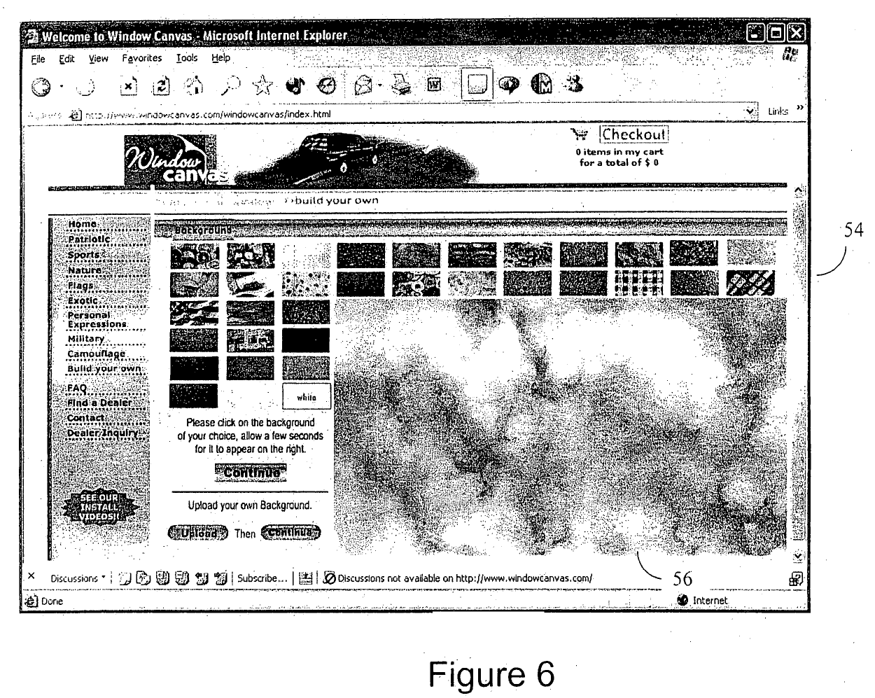

The measurements are stored on the server 20 and a process is initiated that will direct the user 18 to a background selection screen 48, as shown in FIG. 5. Background selection screen 48 contains multiple images 50 from which to choose a background scene for use in design of the individualized image 14. These multiple images 50 are part of the image creation software 16, stored on the server 20. The image creation software 16 also provides an opportunity for the user to upload (or import) their own graphic image file into the image creation software 16 by selecting an upload option 52. Whether selecting a graphical background made available by the system 50 or choosing the upload option 52, a selected background 56 will be displayed on a background display screen 54, as shown in FIG. 6. The image is sized according to the measurements previously entered, however it can be moved on the display, within a bounded region, to position it as desired.

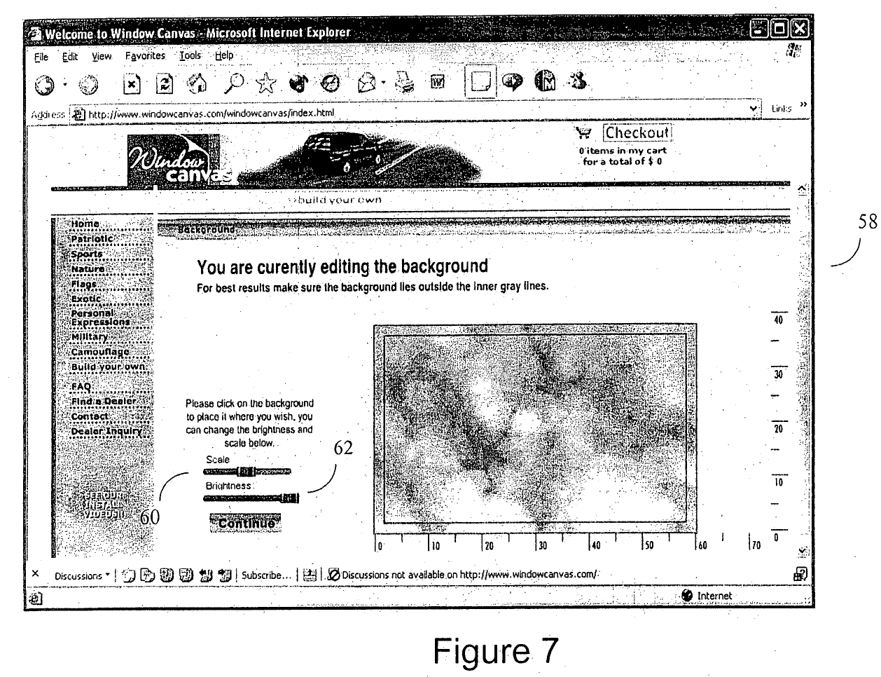

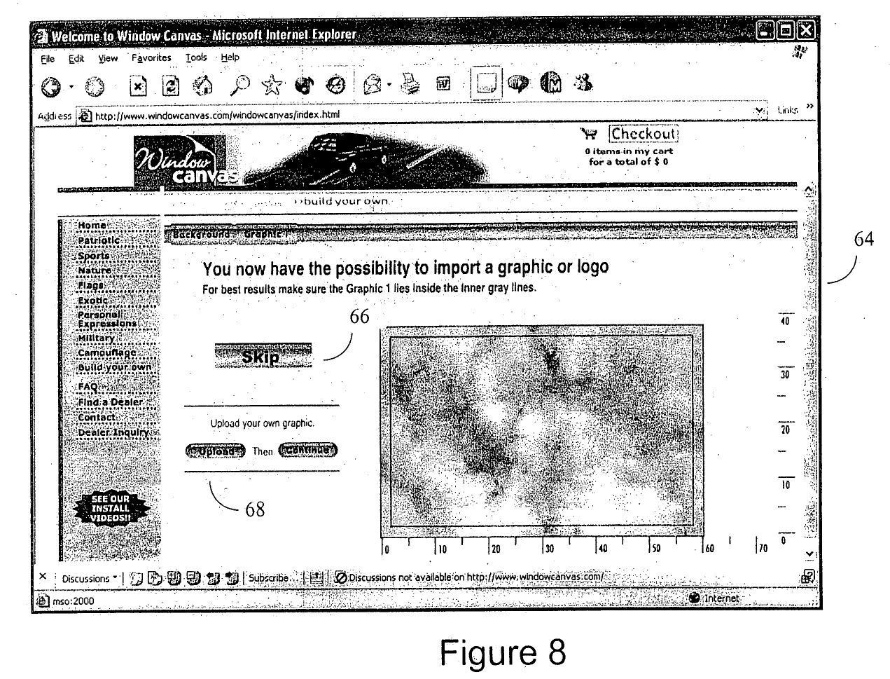

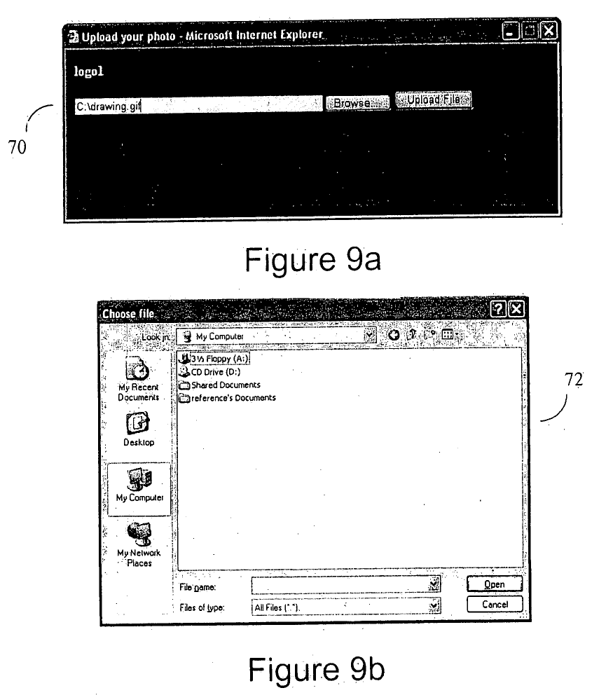

Several features of a selected background image 56, may be modified by the user 18 using interactive software processes. A representative background edit screen 58, as shown in FIG. 7, includes scaling control 60 and brightness control 62. The user 18 indicates completion of editing by selecting an onscreen option to save the results and proceed to the next graphic import screen 64, as shown in FIG. 8. An option is presented to upload a graphic or logo 68 to be electronically overlaid on the background image. Selecting the upload option button 68, activates a process that produces a dialog box permitting entry of the file directory path 70 to where the image file is located on the users computer. FIG. 9a illustrates an example where the drawing file is specified in the root directory of the C: logical drive. An option is also provided for supporting browsing through the users file directory structure 72 to search for a graphic file of interest, as shown in FIG. 9b. If no graphic is to be imported, an onscreen option 66, shown in FIG. 8, allows the user to skip this step and go directly to input of textual data.

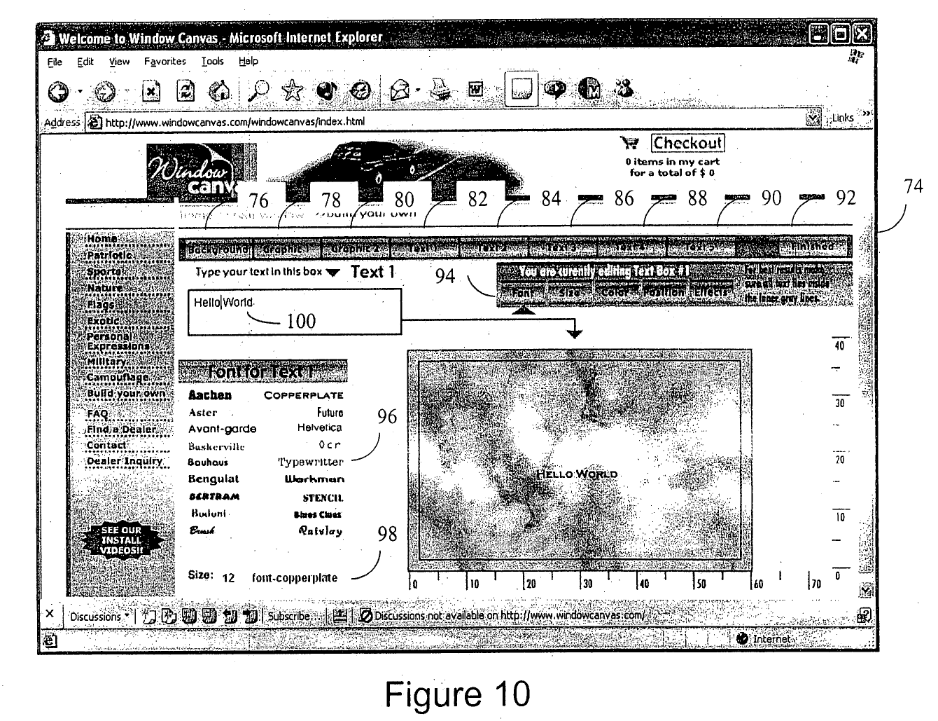

When the user 18 completes editing background characteristics and importing graphics, the user 18 is presented with a display allowing textual data input, as shown in screen image 74, FIG. 10. Text box 1 is the default text box to be edited, and the default screen allows the font 94 to be adjusted. Other modifications to the individualized image 14 can be made from this screen as indicated in the uppermost toolbar on the screen 74. These modifications include changing the background image 76, inserting a first graphic image 78, inserting a second graphic image 80, and inserting up to five (5) sets of textual data 82-90. Each of these toolbar selections directs the software to a process that handles the associated image modification task and displays the appropriate user interface to perform those image modifications.

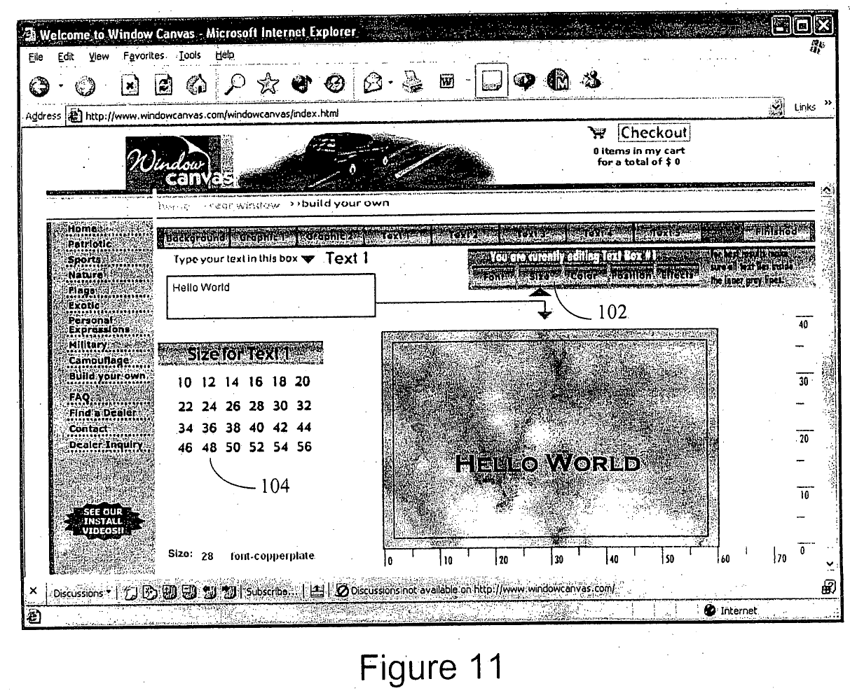

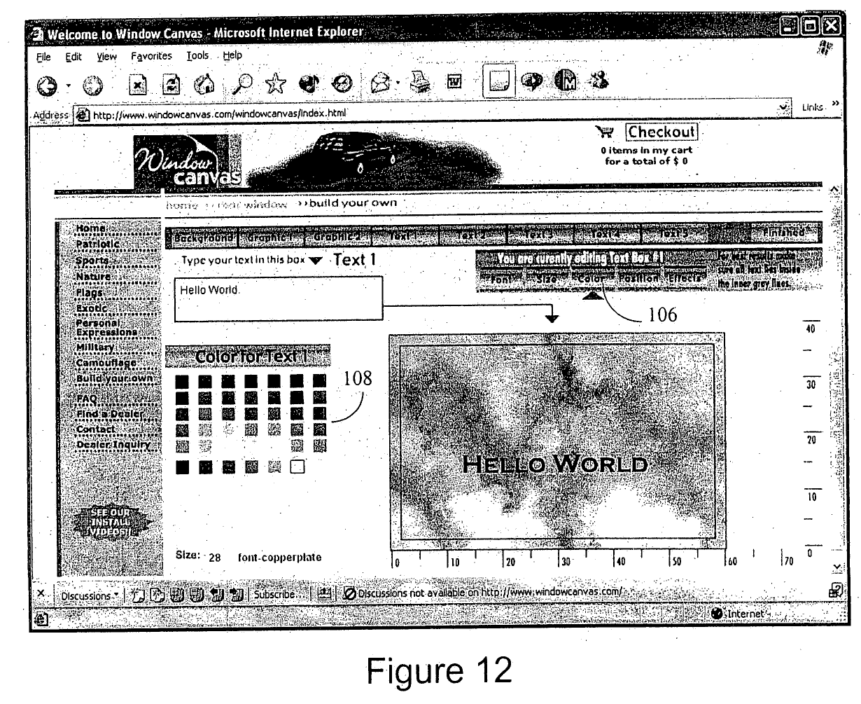

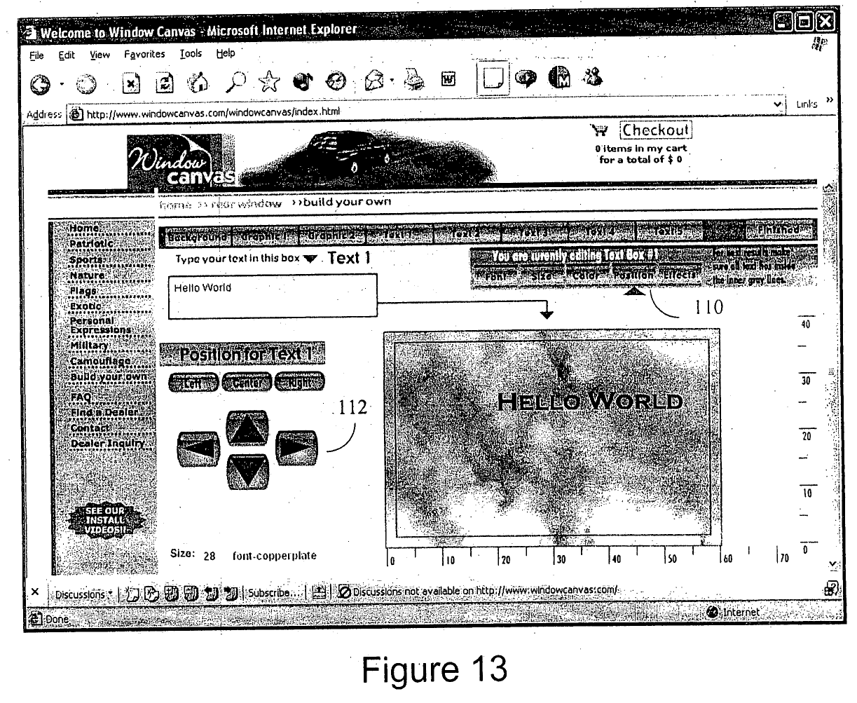

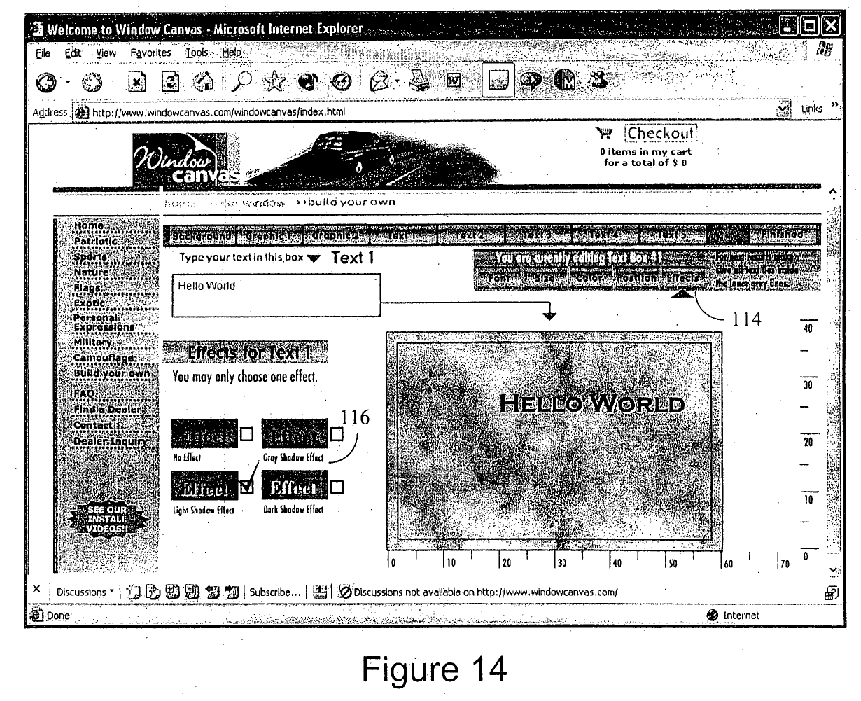

Within screen 74, a textbox 100 is displayed, allowing the user 18 to enter desired text. The text is overlaid on the background image in the currently selected font size and style 98 as characters are entered. Item 96 permits adjustment of the selected font style as desired. Additional changes to the text are accomplished by selecting another option in the secondary toolbar associated with the current text box. Selection of the text size button 102, FIG. 11, initiates a process that presents a window whereby the font size 104 for the text may be adjusted, smaller or larger, from the initial default value. Font color may also be adjusted by selecting the text color button 106, which initiates a process that presents a window similar to that shown in FIG. 12, whereby font color can be chosen from a set of available colors 108. The color is formed by a combination of hue, saturation and brightness. The placement of the textual data on the background image can be manipulated by user selection of the Position button 110 as shown in the text toolbar of FIG. 13. A process is initiated, and a set of controls 112 are displayed that allow interactive and real-time movement of the text, overlaid on the background image, within the boundaries of the media as represented on-screen. Note in the Figure, a bounding box placed within the view of the background identifying that area of the image where text may be positioned. Additionally, by selection of the effects button 114 in the Text Box editing toolbar, shown in FIG. 14, the overlaid text can be subject to a group of special effects 116 such as shadow effects.

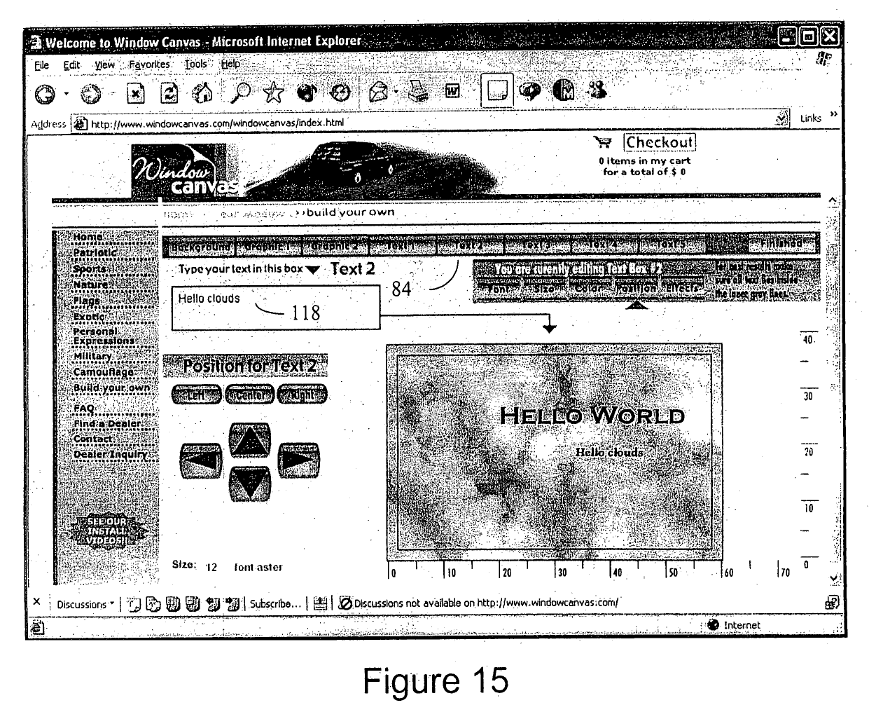

Multiple lines of text can be overlaid on the image by selecting another text button 82-90, e.g. Text2 84, from the uppermost toolbar as shown in FIG. 15. The additional line of text 120 is subject to the same options and restrictions as the first line of text described above.

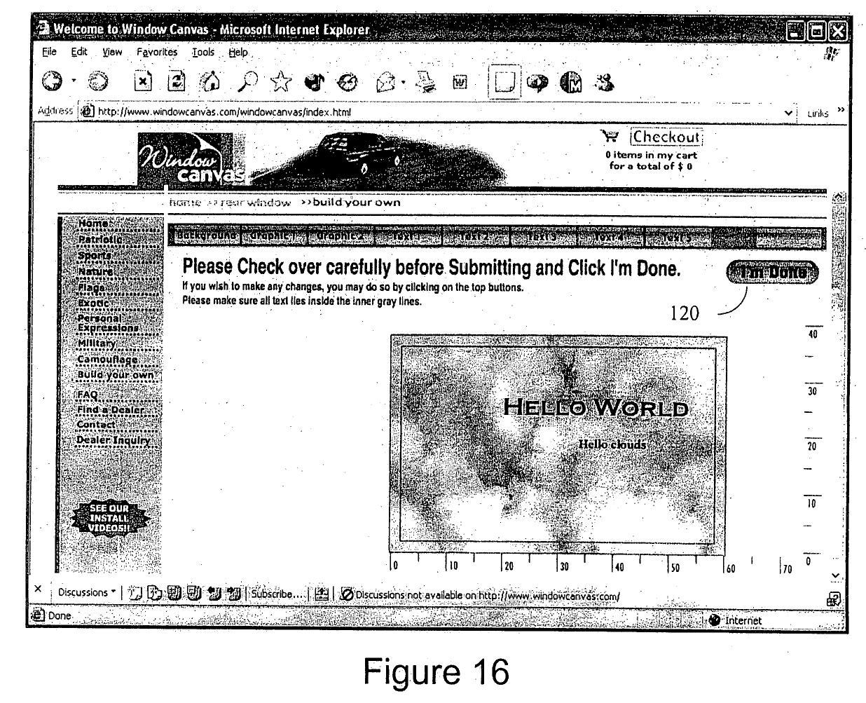

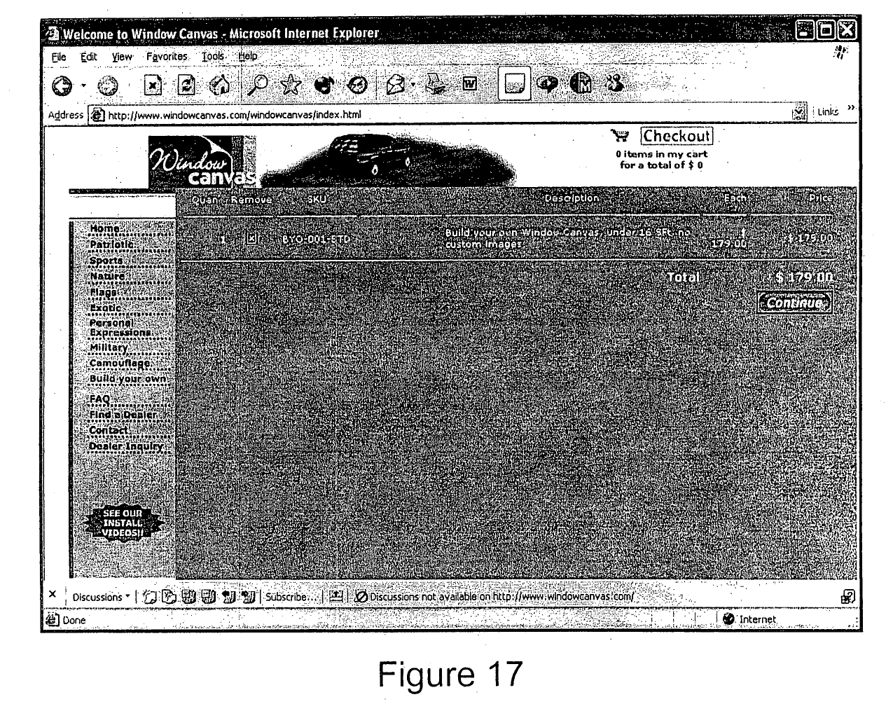

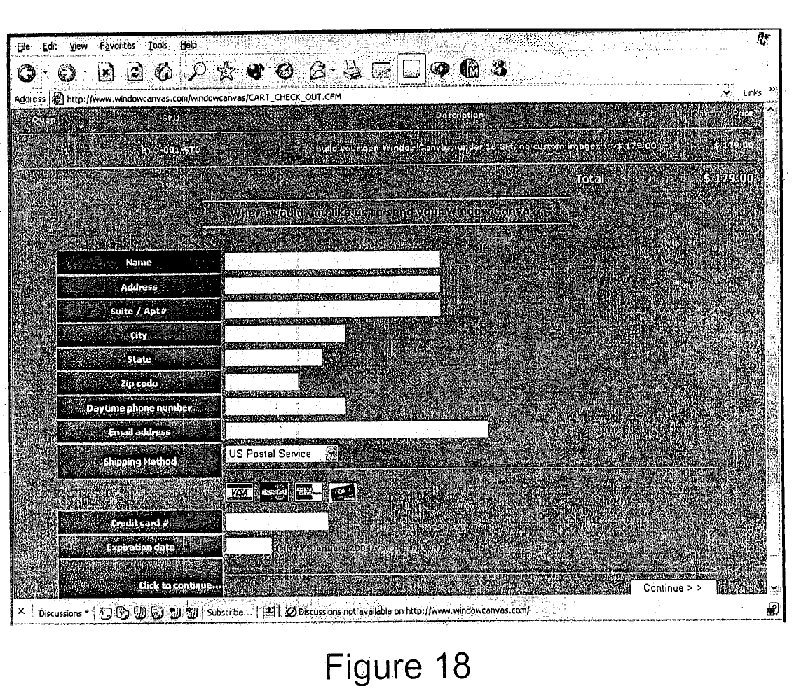

When the user 18 completes the desired selection of options available to create an individualized image 14, the user 18 is prompted to check the work carefully and then submit the order by selecting the “I'm done” button 120, as shown in FIG. 16. This button activates a process that evaluates the order and generates an invoice. FIG. 17 shows an example invoice generated for the order of one individualized image 14 to be printed on a vinyl media for application on the rear window of a vehicle. If approved by the user 18, a subsequent process presents an on-screen form, FIG. 18, that allows the user 18 to provide shipping and billing information as required for order processing. Actual order processing can be accomplished through an intermediary ordering service 24 either virtually through the network 22 or physically from a “bricks and mortar” retail location. In this case, the ordering service 24 forwards the order to the manufacturer 10 for product fulfillment. Alternatively the virtual order can be processed directly by said manufacturer 10. In all cases, the individualized image 14 results in a printed product 12 that subsequently ships to the user 18 directly from the manufacturer or indirectly through an intermediary ordering service 24 for distribution to the user 18.

A second embodiment of the present invention relates to the design and production of customized images on media for use on non-opaque materials in applications such as a building window, an ornamental window, and a manufactured product like a drinking glass. It is apparent that little change to the described system and method would be necessary to meet the requirements of this embodiment.

A third embodiment of the present invention pertains to media that can be applied on opaque material surfaces. Examples of such surfaces include vehicular body parts, building surfaces, and manufactured products. In this case, the image is not expected to be seen through the material by an observer, as was the case with the prior two embodiments, but rather the media would be applied to the surface of the material that would be viewed by the observer. There would be no change needed to the system or method as described herein, only changes to the type of media and the printing process used by the manufacturer.

Although only a small number of exemplary embodiments of the present invention have been described above, those skilled in the art will readily appreciate that numerous modifications to the exemplary embodiments that are possible without materially departing from the novel teachings and advantages of this invention. Accordingly, all such modifications are intended to be included within the scope of this invention as defined above and in the accompanying drawings.

1) A system for electronically generating individualized graphic images applied on media and affixed to a material comprising:
at least one computer operatively associated with:
i) a first data-store for storage of user-specifiable images;
ii) a second data-store for storage of linear measurements associated with said media;
iii) a third data store for storage of optional user-specified text electronically overlaid upon said user-selectable image;
a user interface operatively associated with said computer for enabling dialogue between a user and said system for specifying said images, said linear measurements and said text;
a data display device operatively associated with said computer for viewing said images, said linear measurements, and said text;
at least one computer process operatively associated with said system for manipulating the image data, the linear measurement data, and said text;
wherein said individualized graphic image is prepared and transmitted to a manufacturer for product fulfillment.

2) The system of claim 1, wherein communication between said user and said system can occur over a computer network comprising any of a LAN, WAN, VPN, and the Internet.

3) The network of claim 2, wherein the individualized graphic image can be transferred to an intermediary ordering service prior to receipt by said manufacturer.

4) The system of claim 1, wherein the application of said material comprises a vehicle window, a building window, an ornamental window, and other manufactured products.

5) The system of claim 1, wherein said linear measurements can be chosen from a store of measurements corresponding to selectable vehicle types.

6) The system of claim 1, wherein said user-specified image can be chosen from a selection of stored images.

7) The system of claim 1, wherein said user-specified image can be provided to said system over said computer network.

8) The system of claim 1, wherein said user-specified image can be edited by said user.

9) The system of claim 1, wherein said user specified text can be edited by said user.

10) A method for electronically generating individualized graphic images applied on media and affixed to a material comprising the steps of:
i) establishing dialogue with an individualized graphic image manufacturer;
ii) specifying linear measurements for the size of said media;
iii) obtaining a graphic image;
iv) placing a view of said graphic image on a view of said media;
v) editing a view of said graphic image;
wherein said individualized graphic image is prepared and transmitted to the manufacturer for product realization.

11) The method of claim 10, wherein said dialogue is established between a user and said manufacturer through a user-interface, and at least one computer process via a computer network.

12) The method of claim 11, wherein said dialogue between said user and said manufacturer can be accomplished through an intermediary ordering service.

13) The method of claim 10, wherein said individualized graphic image comprises a combination of hue, saturation and brightness.

14) The method of claim 10, wherein specifying said individualized graphic image comprises a listing of a plurality of selectable images.

15) The method of claim 10, wherein specifying said individualized graphic image optionally comprises retrieval of a selected image from a user.

16) The method of claim 10, wherein said individualized graphic image is freely positioned and sized within a bounded region defined by a fraction of said view of said media.

17) The method of claim 10, wherein said individualized graphic image optionally comprises text overlaid on said graphic image.

18) The method of claim 17, wherein said text comprises a combination of font style, font hue, font saturation, font brightness, font size, and font special effects.

19) The method of claim 17, wherein the overlaid text is freely positioned within a bounded region defined by a fraction of said view of said media.

20) The method of claim 10, wherein said individualized graphic image applied on media is delivered to said user.
